(19) United States
(12) Patent Application Publication
(10) Pub. No.: US 2016/0315389 A1
(43) Pub. Date: Oct. 27, 2016

(54) ANTENNA COMPONENT

(71) Applicant: MURATA MANUFACTURING CO., LTD., NAGAOKAKYO-SHI (JP)

(72) Inventors: RYOJI IMAI, NAGAOKAKYO-SHI (JP); TAKESHI ARAI, NAGAOKAKYO-SHI (JP); TSUGUMICHI NAGAOKA, NAGAOKAKYO-SHI (JP)

(21) Appl. No.: 15/202,999

(22) Filed: Jul. 6, 2016

Related U.S. Application Data
(63) Continuation of application No. PCT/JP2014/082430, filed on Dec. 8, 2014.

(30) Foreign Application Priority Data
Jan. 20, 2014 (JP) 2014-007726

(51) Int. Cl. H01Q 7/08; H01Q 1/24; H01Q 1/52; H01Q 1/36

(52) U.S. Cl. CPC H01Q 7/08; H01Q 1/36; H01Q 1/24; H01Q 1/52

(57) ABSTRACT

An antenna component providing a large output. The antenna component can be attached to a metallic body and includes a main body having a core and a coil antenna wound on a circumference of the core, a metallic member with a lower resistivity than the metallic body and provided between the coil antenna and the metallic body. Moreover, a porous member is sandwiched between the coil antenna and the metallic member to maintain a predetermined distance between the coil antenna and the metallic member.

### CROSS REFERENCE TO RELATED APPLICATIONS

The present application is a continuation of PCT/JP2014/082430 filed Dec. 8, 2014, which claims priority to Japanese Patent Application No. 2014-007726, filed Jan. 20, 2014, the entire contents of each of which are incorporated herein by reference.

### FIELD OF THE INVENTION

The present invention relates to antenna components, and more specifically relates to antenna components that are used being attached to metallic bodies.

### BACKGROUND

Conventional antenna components, such as an antenna coil disclosed in Patent document 1, is known, for example. The stated antenna coil includes a wound body, a case, and a foam body. The wound body includes a magnetic core, a bobbin surrounding the magnetic core, and a coil wound on the bobbin. The case accommodates the wound body. The foam body is provided on a circumference of the wound body in the case. According to the antenna coil disclosed in Patent Document 1, breakage of the magnetic core can be prevented.

Note that a larger output is currently required with the antenna coil disclosed in Patent Document 1.

Patent Document 1: Japanese Patent No. 5003688.

### SUMMARY OF THE INVENTION

An object of the present disclosure is to provide an antenna component from which a large output can be obtained.

An antenna component according to a first aspect, an antenna component is provided that is attachable to a metallic body and includes a main body having a core and a coil antenna wound on a circumference of the core, a metallic member having a lower resistivity than the metallic body and provided between the coil antenna and the metallic body, and a porous member that is sandwiched between the coil antenna and the metallic member and maintains a predetermined distance between the coil antenna and the metallic member.

In an antenna component according to a second aspect, the porous member has elasticity and is compressed being sandwiched between the coil antenna and the metallic member.

An antenna component according to a third aspect further includes a case for accommodating the main body, the metallic member, and the porous member.

In an antenna component according to a fourth aspect, the metallic member is, when viewed from above in a first direction in which the metallic member and the porous member overlap with each other, formed in a rectangular plate shape having a lengthwise direction side in a second direction orthogonal to the first direction; the case is formed in a rectangular parallelepiped shape having a lengthwise direction side in the second direction and is opened in a surface on one side in the second direction; and at least one of long sides of the metallic member is folded back toward the main body.

In an antenna component according to a fifth aspect, the metallic member is, when viewed from above in the first direction in which the metallic member and the porous member overlap with each other, formed in a rectangular plate shape having a lengthwise direction side in the second direction orthogonal to the first direction; the case is formed in a rectangular parallelepiped shape having a lengthwise direction side in the second direction and is opened in a surface on one side in the second direction; and a short side of the metallic member on the other side in the second direction is folded back toward the main body.

In an antenna component according to a sixth aspect, the metallic member comprises copper or aluminum.

According to the present disclosure, the antenna component can provide a large output.

### BRIEF DESCRIPTION OF DRAWINGS

FIG. 1 is a plan view of an antenna component when viewed from above according to an exemplary embodiment.

FIG. 2 is a plan view of the antenna component when viewed from the right side according to an exemplary embodiment.

FIG. 3 is a cross-sectional structure view of the antenna component according to an exemplary embodiment.

FIG. 4 is a plan view of a main body of the antenna component when viewed from above according to an exemplary embodiment.

FIG. 5 is a plan view of the main body of the antenna component when viewed from the right side according to an exemplary embodiment.

FIG. 6 is a graph indicating a relationship between output of the antenna component and a distance in an up-down direction between a coil antenna and a metal plate according to an exemplary embodiment.

FIG. 7 is a plan view of an antenna component when viewed from the right side according to an exemplary embodiment.

FIG. 8 is a cross-sectional structure view of the antenna component according to an exemplary embodiment.

### DETAILED DESCRIPTION

(Configuration of Antenna Component)

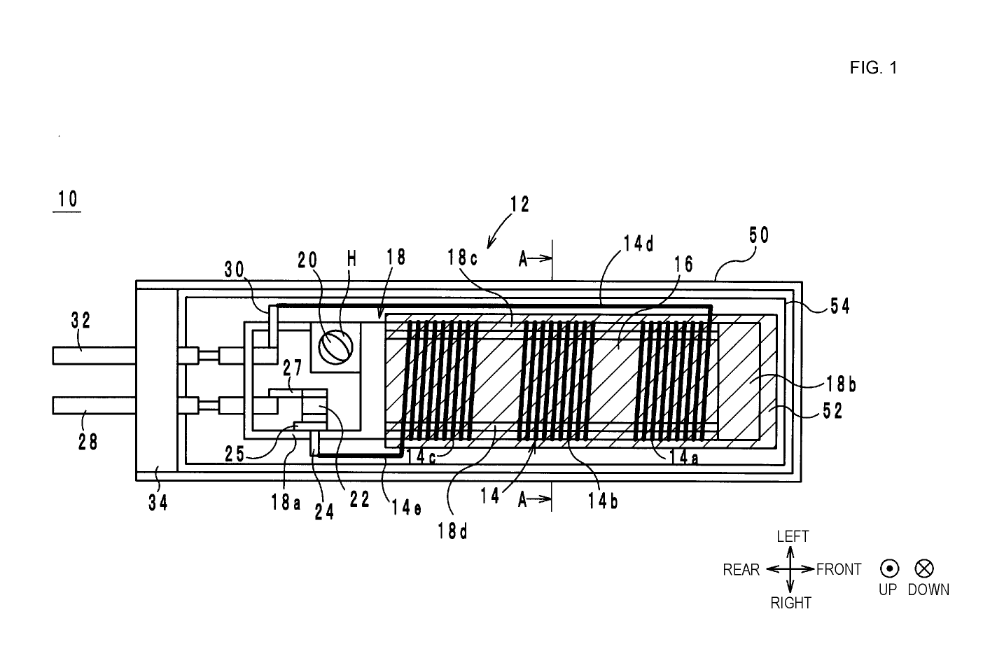

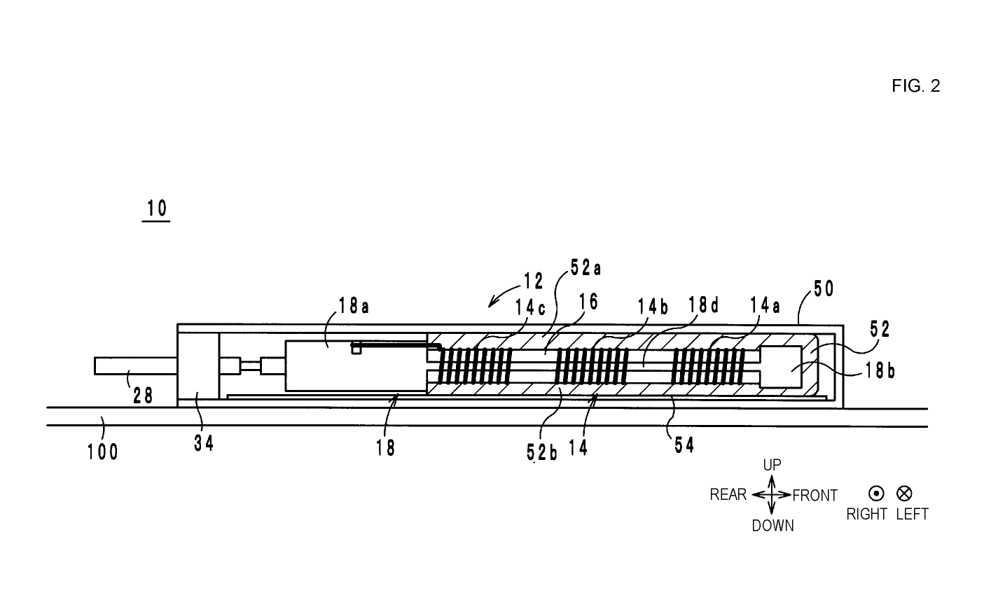

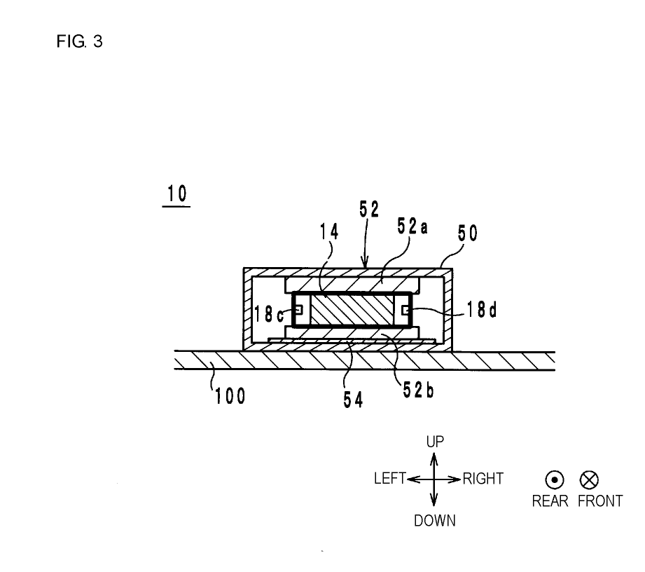

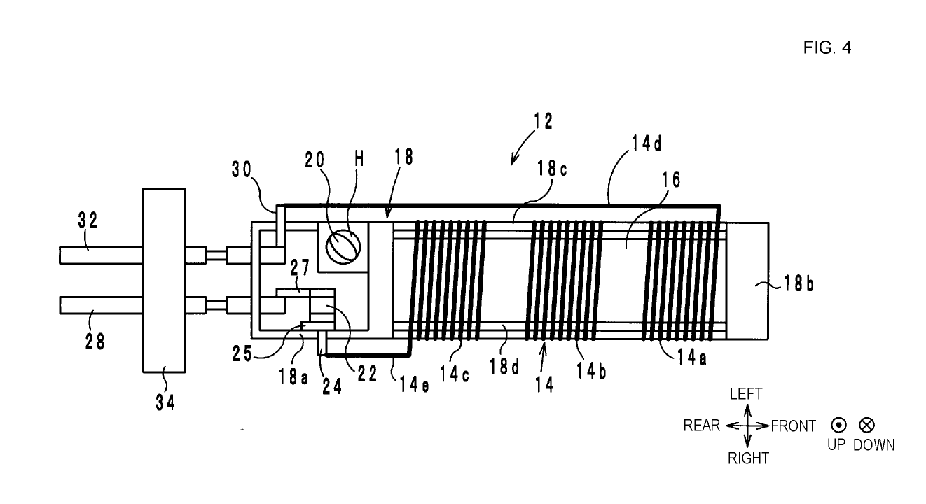

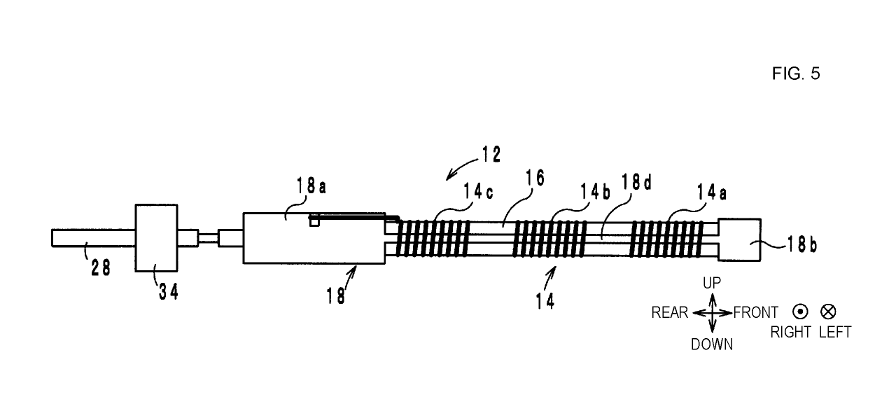

Hereinafter, a configuration of an antenna component according to an embodiment will be described with reference to the drawings. FIG. 1 is a plan view of an antenna component 10 when viewed from above. FIG. 2 is a plan view of the antenna component 10 when viewed from the right side. FIG. 3 is a cross-sectional structure view of the antenna component 10. FIG. 4 is a plan view of a main body 12 of the antenna component 10 when viewed from above. FIG. 5 is a plan view of the main body 12 of the antenna component 10 when viewed from the right side. Note that FIG. 1 illustrates the antenna component 10 with a porous member 52 being seen through.

Here, a lengthwise direction of the antenna component 10 is defined as a front-rear direction. A width direction of the antenna component 10 is defined as a right-left direction. Further, a thickness direction of the antenna component 10 is defined as an up-down direction. The front-rear direction, the right-left direction, and the up-down direction are orthogonal to each other. Note that the front-rear direction, the right-left direction, and the up-down directions are defined for convenience. As such, the directions defined as described above for convenience are not needed to match actual front-rear, right-left, and up-down directions of the antenna component 10 in use.

The antenna component 10 is a transmission antenna component of an LF band (30 kHz to 300 kHz) short-range communication system and is mainly used in a keyless entry system to lock/unlock a vehicle door by remote control. The above-mentioned antenna component 10 is normally provided inside the vehicle door. To be specific, as shown in FIGS. 2 and 3, the antenna component 10 is used being attached to a rear surface of a door panel 100 which is a metallic body made of a material containing iron. Note that the material of the door panel 100 may be a metal other than iron.

As shown in FIG. 1, the antenna component 10 includes the main body 12, a small core 20, a capacitor 22, terminals 24 and 30, electrodes 25 and 27, external terminals 28 and 32, a cap 34, a case 50, the porous member 52, and a metal plate 54.

The main body 12 includes a coil antenna 14 having a coil section where a conductive wire is spirally wound about a coil axis of the coil antenna, a core 16, and a bobbin 18. The core 16 is a plate-like member formed in a rectangular shape having a lengthwise direction side in the front-rear direction when viewed from above. According to an exemplary embodiment, impalpable powder of Mn—Zn based ferrite, amorphous-based magnetic material other than the Mn—Zn based ferrite, or the like is compressed to form a plate-like shape and then calcined, for example, so as to produce the core 16. The direction of the coil axis of the coil conductive section matches the lengthwise direction of the antenna component 10.

The bobbin 18 is provided to protect the core 16 and suppresses the breakage of the core 16 due to deformation, shocks, or the like being applied during the manufacturing, usage of the product, or the like. The bobbin 18 is formed in a rectangular frame shape surrounding a circumference of the core 16 when viewed from above and includes a base portion 18a, a leading end portion 18b, and connection portions 18c and 18d.

The leading end portion 18b is a rectangular parallelepiped box having a lengthwise direction side in the right-left direction. Note that the leading end portion 18b is opened in a rear surface thereof. A front end of the core 16 is inserted into the leading end portion 18b from the rear side of the leading end portion 18b.

The base portion 18a is formed in a rectangular frame shape when viewed from above. There is provided an opening in a front surface of the base portion 18a. A rear end of the core 16 is inserted through the opening of the base portion 18a from the front side. With this, the core 16 is held by the bobbin 18.

The connection portion 18c connects a left surface of the leading end portion 18b and a left surface of the base portion 18a, and has a belt-like shape extending in the front-rear direction. The connection portion 18c extends in the front-rear direction on the left side relative to a left surface of the core 16.

The connection portion 18d connects a right surface of the leading end portion 18b and a right surface of the base portion 18a, and has a belt-like shape extending in the front-rear direction. The connection portion 18d extends in the front-rear direction on the right side relative to a right surface of the core 16.

The bobbin 18 constituted as described above is produced by integral formation using polybutylene terephthalate (PBT).

A conductive wire in which the surface of a core wire made of a conductive material such as copper or the like is covered with an insulative material is wound on the circumference of the core 16, thereby constituting the coil antenna 14. The coil antenna 14 includes coil sections 14a through 14c and extending sections 14d, 14e.

The conductive wire is wound on the circumference of the core 16 and the connection portions 18c, 18d near the front end thereof so as to constitute the coil section 14a in spiral form. Further, the conductive wire is wound on the circumference of the core 16 and the connection portions 18c, 18d near the center thereof in the front-end direction so as to constitute the coil section 14b in spiral form. The conductive wire is also wound on the circumference of the core 16 and the connection portions 18c, 18d near the rear end thereof so as to constitute the coil section 14c in spiral form. The coil sections 14a through 14c are wound in the same direction in terms of wire-winding and are electrically connected in series in that order.

The extending section 14d is connected to a front end of the coil section 14a and extends from the left side near the front end of the core 16 to the left side of the base portion 18a. The extending section 14e is connected to a rear end of the coil section 14c and extends from the right side near the rear end of the core 16 to the right side of the base portion 18a.

According to the exemplary embodiment, the terminal 24 can be made of a conductive member such as copper or the like and extends in the right-left direction so as to penetrate the right surface of the base portion 18a. A right end of the terminal 24 is connected to the extending section 14e.

Moreover, the terminal 30 can also be made of a conductive member such as copper or the like and extends in the right-left direction so as to penetrate the left surface of the base portion 18a. A left end of the terminal 30 is connected to the extending section 14d.

The electrode 25 is provided on the right surface side of the base portion 18a and connected to a left end of the terminal 24. The electrode 27 is provided on the left side relative to the electrode 25. The capacitor 22 is connected between the electrode 25 and the electrode 27. This makes the coil antenna 14 and the capacitor 22 be connected in series. The coil antenna 14 and the capacitor 22 configure a resonance circuit. By making a resonant frequency of the resonance circuit configured of the coil antenna 14 and the capacitor 22 match a transmission signal frequency, a large coil current is obtained and consequently a large magnetic field output can be realized even at a low voltage.

The small core 20 is provided on an upper-right corner of the base portion 18a when viewed from above. To be more specific, a bottomed hole H is provided on the upper-right corner of the base portion 18a. The bottomed hole H is formed in a circular shape when viewed from above. The small core 20 is formed in an elliptical shape and is attached inside the hole H. With this configuration, magnetic flux generated by the coil antenna 14 passes through the small core 20. Further, rotating the small core 20 in the hole H changes a distance between the small core 20 and the core 16, whereby a coupling amount of magnetic flux is changed. This makes it possible to adjust inductance of the coil antenna 14. It is reiterated that it is not required to provide the above-discussed capacitor 22, small core 20, or the like, and that these components are only provided according to one embodiment.

As further shown, the cap 34 is provided at a rear side of the main body 12 and is formed in a rectangular shape having a lengthwise direction side in the left-right direction when viewed from above. A length of the cap 34 in the right-left direction is slightly longer than a width of the main body 12 in the right-left direction, and a thickness of the cap 34 in the up-down direction is slightly larger than a thickness of the main body 12 in the up-down direction. The cap 34 is made of a resin such as polybutylene terephthalate (PBT) or the like, for example.

The external terminal 28 extends in the front-rear direction to penetrate a rear surface of the base portion 18a and the cap 34 in the front-rear direction. A front end of the external terminal 28 is connected to the electrode 27. The external terminal 28 is made of a conductive material such as copper or the like.

The external terminal 32 extends in the front-rear direction to penetrate the rear surface of the base portion 18a and the cap 34 in the front-rear direction on the left side relative to the external terminal 28. A front end of the external terminal 32 is connected to terminal 30. The external terminal 32 is made of a conductive material such as copper or the like.

The porous member 52 is a belt-like member that is spread extending in the front-rear direction and is folded in two at the center thereof in the front-rear direction. Hereinafter, of the porous member 52 folded in two, a portion positioned on the upper side is referred to as an upper portion 52a while a portion positioned on the lower side is referred to as a lower portion 52b. The porous member 52, when viewed from above in a normal direction of the antenna component, overlaps with the coil sections 14a through 14c in a state of being folded in two. In other words, the coil sections 14a through 14c are sandwiched between the upper portion 52a and the lower portion 52b in the up-down direction. The porous member 52 is an elastic foam member in which innumerable holes are formed, and a sponge can be cited as an example of the stated foam member.

A sponge having a restoring force that is disposed being compressed between an outer side portion of the coil antenna 14 and the inside of the case 50 presses the coil antenna 14. The restoring force of the sponge elastically supports the coil antenna 14 in the up-down direction and the right-left direction. In addition, the coil antenna 14 is also elastically supported in the front-rear direction by the restoring force of the sponge and a friction force between the sponge and the coil antenna 14. The above-mentioned elastic supports can alleviate a shock transmitted to the coil antenna 14 in the up-down, right-left, and front-rear directions, and the restoring force of the sponge can maintain a predetermined distance between the coil antenna 14 and the case 50. Further, the porous structure of the sponge brings a favorable effect that reduces thermal conductivity, which consequently brings an effect that can delay a change in temperature of the coil antenna 14 caused by the heat transmitted from the case 50 to the coil antenna 14. The antenna component is disposed in the vicinity of the door panel 100, where the antenna component is likely to be affected by environmental changes. As such, the coil antenna 14 surrounded by the porous member 52 has such an advantage that the deformation thereof caused by thermal stress can be alleviated and the generation of condensation can be reduced by the above-mentioned effect of the porous member 52 delaying the temperature change.

Further, the porous member 52 embraces the coil sections 14a through 14c of the coil antenna 14 when viewed from above. In other words, the coil sections 14a through 14c do not stick out from the porous member 52 when viewed from above.

The metal plate 54 is a metallic member constituted by a metal material (copper or aluminum) having a lower resistivity than the door panel 100 and is also a plate member that is formed in a rectangular shape having a lengthwise direction side in the front-rear direction when viewed from above. The metal plate 54 is provided on the lower side relative to the porous member 52. With this, the upper portion 52a, the main body 12, the lower portion 52b, and the metal plate 54 are aligned in that order from the upper side toward the lower side. That is, the lower portion 52b is sandwiched between the main body 12 and the metal plate 54 in the up-down direction. Thus, when the material of the door panel 100 is iron or an alloy of iron, the metal plate 54 having a lower resistivity than the door panel 100 can be aluminum, an alloy of aluminum, copper, or an alloy of copper. Further, when the material of the door panel 100 is aluminum or an alloy of aluminum, the metal plate 54 having a lower resistivity than the door panel 100 can be copper or an alloy of copper.

According to the exemplary embodiment, the metal plate 54 embraces the coil sections 14a through 14c of the coil antenna 14 when viewed from above. That is, the coil sections 14a through 14c do not stick out from the metal plate 54 when viewed from above. In the exemplary embodiment, the main body 12 (that is, the coil antenna 14, the core 16, and the bobbin 18) does not stick out from the metal plate 54 when viewed from above.

According to the exemplary embodiment, the case 50 is formed in a rectangular parallelepiped shape having a lengthwise direction side in the front-rear direction and is opened in its rear side surface. The case 50 is made of a resin, for example, and accommodates the main body 12, the small core 20, the capacitor 22, the terminals 24 and 30, the electrodes 25 and 27, the cap 34, the porous member 52, and the metal plate 54. More specifically, when the main body 12 is sandwiched by the porous member 52 in the up-down direction and the metal plate 54 is disposed under the lower portion 52b of the porous member 52, the main body 12, the porous member 52, and the metal plate 54 are inserted from the opening at the rear side of the case 50. Then, the opening at the rear side of the case 50 is covered with the cap 34 so that the interior of the case 50 is sealed. Note that a gap between the cap 34 and the case 50 may be filled with a resin or the like so as to seal the interior of the case 50. Before the above insertion, a thickness in the up-down direction of an assembly body formed of the upper portion 52a, the main body 12, the lower portion 52b, and the metal plate 54 is slightly larger than the thickness of the case 50 in the up-down direction. As such, the upper portion 52a is sandwiched between an upper surface of the case 50 and the main body 12 to be compressed in the up-down direction. Meanwhile, the lower portion 52b is sandwiched between the main body 12 and the metal plate 54 to be compressed in the up-down direction. With this, the lower portion 52b of the porous member 52 functions as a spacer that maintains a predetermined distance between the coil antenna 14 and the metal plate 54.

The antenna component 10 configured as discussed above is attached to an upper side of the door panel 100 with an adhesive, a double-faced tape, or the like. Through this, the metal plate 54 is provided between the coil antenna 14 and the door panel 100. Further, a signal generation circuit is connected to the external terminals 28 and 32 of the antenna component 10.

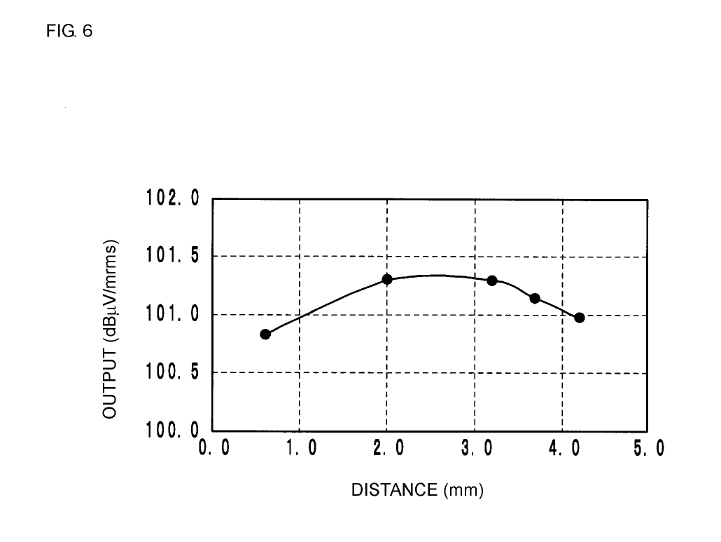

According to the exemplary embodiment, a large output can be obtained with the above-discussed antenna component 10, which will be described below with reference to the drawings. FIG. 6 is a graph indicating a relationship between the output of the antenna component 10 and a distance in the up-down direction between the coil antenna 14 and the metal plate 54. The horizontal axis represents the distance between the coil antenna 14 and the metal plate 54 in the up-down direction, while the vertical direction represents the output of the antenna component 10.

Advantageously, for the coil component 10 disclosed herein, by arranging the metal plate 54 as having a lower resistivity than the door panel 100 between the coil antenna 14 and the door panel 100, the output of the antenna component 10 increased. Specifically, because the magnetic flux generated by the coil antenna 14 passes through the metal plate 54, it is suppressed that the magnetic flux directly passes through the door panel 100. In addition, the inventors of the present invention have found that setting the distance between the coil antenna 14 and the metal plate 54 in the up-down direction to an appropriate value made it possible to increase the output of the antenna component 10 through the following experiment. To be specific, the inventors of the present invention researched a change in output of the antenna component 10 with the distance between the coil antenna 14 and the metal plate 54 being varied in the up-down direction. Conditions under which the experiment was carried out were as follows.

Size of the core 16: 48 mm×7 mm×2.3 mm.

Size of the metal plate 54: 53 mm×12 mm×0.3 mm.

According to FIG. 6, the output of the antenna component 10 was found to be at its maximum in the case where the distance between the coil antenna 14 and the metal plate 54 was approximately 2.5 mm in the up-down direction. In other words, it was found that setting the distance between the coil antenna 14 and the metal plate 54 to an appropriate value in the up-down direction made it possible to increase the output of the antenna component 10.

As such, the porous member 52 is disposed between the coil antenna 14 and the metal plate 54 such that the distance between the coil antenna 14 and the metal plate 54 is maintained at approximately 2.5 mm (predetermined distance). This makes it easy to maintain the distance between the coil antenna 14 and the metal plate 54 at approximately 2.5 mm in the assembly of the antenna coil 10, thereby making it possible to increase the output of the antenna component 10. Note that the above-discussed 2.5 mm is merely an example of the predetermined distance and the predetermined distance is not limited thereto.

In the antenna component 10, capacitance is formed between the coil antenna 14 and the metal plate 54. Formation of a large amount of capacitance between the coil antenna 14 and the metal plate 54 leads to a decrease in the output of the antenna component 10.

Accordingly, in the antenna component 10, the porous member 52 is provided between the coil antenna 14 and the metal plated 54. With this, a large amount of air is present between the coil antenna 14 and the metal plate 54. That is, a relative dielectric constant of a portion between the coil antenna 14 and the metal plate 54 is suppressed to be low, whereby the formation of a large amount of capacitance between the coil antenna 14 and the metal plate 54 is suppressed. As a result, a large output can be obtained in the antenna component 10.

As discussed above, providing the porous member 52 makes it easy to maintain the distance between the coil antenna 14 and the metal plate 54 at approximately 2.5 mm in the assembly of the antenna component 10. As such, the antenna component 10 can be easily assembled.

Further, the metal plate 54 is provided so as to embrace the coil sections 14a, 14b, 14c and the core 16 and also overlaps with the coil sections 14a, 14b, 14c and the core 16, when viewed from above. With this, it is suppressed that the magnetic flux generated by the coil antenna 14 directly passes through the door panel 100 without passing through the metal plate 54. As a result, a large output can be obtained in the antenna component 10.

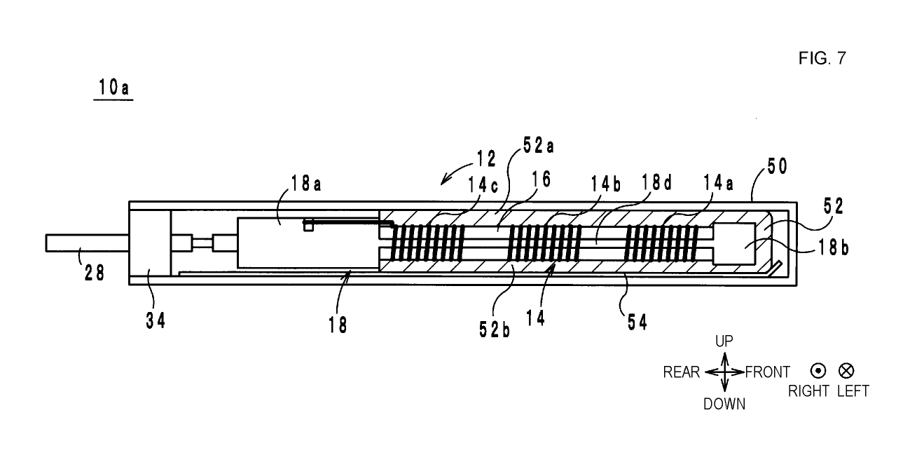

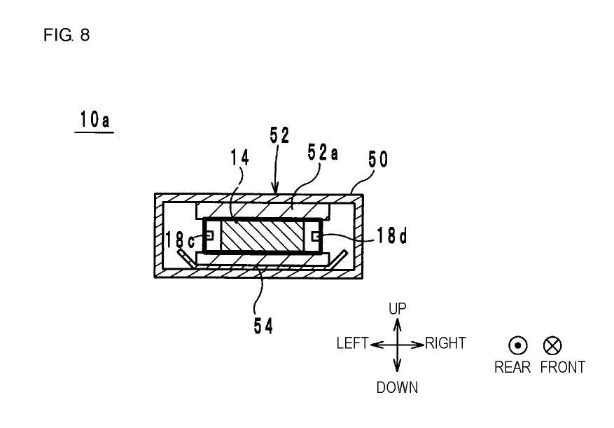

Hereinafter, an antenna component 10a according to a variation will be described with reference to the drawings. FIG. 7 is a plan view of the antenna component 10a when viewed from the right side according to this embodiment. FIG. 8 is a cross-sectional structure view of the antenna component 10a.

A shape of the metal plate 54 of the antenna component 10a differs from the shape of the metal plate 54 of the antenna component 10. To be more specific, in the antenna component 10a, long sides of the metal plate 54 on both the sides in the right-left direction are folded back toward the main body 12 (toward the upper side). Further, in the antenna component 10a, a short side of the metal plate 54 on the front side is folded back toward the main body 12 (toward the upper side).

With the antenna component 10a, like the antenna component 10, a large output can be obtained according to the exemplary embodiment.

In addition, a large output can be obtained in the antenna component 10a because of the following reasons as well. More specifically, the long sides of the metal plate 54 on both the sides in the right-left direction and the short side thereof on the front side are folded back toward the main body 12. This makes a lower half of the coil antenna 14 be surrounded by the metal plate 54 from the front side and the right and left sides. As such, it is suppressed that the magnetic flux generated by the antenna coil 14 directly passes through the door panel 100 without passing through the metal plate 54. As a result, a large output can be obtained in the antenna coil 10a.

Note that the short side of the metal plate 54 on the front side is bent toward the main body 12 in the antenna component 10a. With this, the short side of the metal plate 54 on the front side is unlikely to be caught by the case 50 when it is inserted into the case 50, thereby making it easy to insert the metal plate 54 into the case 50.

Further, the long sides of the metal plate 54 on both the sides in the right-left direction are bent toward the main body 12. With this, the long sides of the metal plate 54 on both the sides in the right-left direction are unlikely to be caught by the case 50 when they are inserted into the case 50, thereby making it easy to insert the metal plate 54 into the case 50.

### Other Embodiments

The antenna component according to the present disclosure is not limited to the antenna components 10 and 10a, and can be modified within the spirit of the invention.

Although the antenna components 10 and 10a are attached to the door panel 100, they may be attached to a metal other than the door panel 100.

The porous member 52 may be a member other than the sponge, and may be, for example, styrene foam or the like.

The material of the metal plate 54 is not limited to copper or aluminum, and the metal plate 54 may be made of other metal materials.

In the antenna component 10a, only any one of the long sides of the metal plate 54 in the right-left direction may be folded back.

### INDUSTRIAL APPLICABILITY

As discussed thus far, the present invention is useful for antenna components and particularly has an advantage in that a large output can be obtained.

### REFERENCE SIGNS LIST

10, 10a ANTENNA COMPONENT
12 MAIN BODY
14 COIL ANTENNA
14a-14c COIL SECTION
16 CORE
18 BOBBIN
50 CASE
52 POROUS MEMBER
54 METAL PLATE
100 DOOR PANEL

1. An antenna component attachable to a metallic body, comprising:
a main body including a core extending in a longitudinal direction and a coil antenna wound about the core; and
a metallic member extending in the longitudinal direction and disposed between the coil antenna and the metallic body with a distance therebetween,
wherein the metallic member has a lower resistivity than the metallic body.

2. The antenna component according to claim 1, further comprising a case accommodating the main body and the metallic member.

3. The antenna component according to claim 2, further comprising a porous member disposed in the case and between the coil antenna and the metallic member to maintain the distance between the coil antenna and the metallic member.

4. The antenna component according to claim 1, wherein the porous member has elasticity and is compressed between the coil antenna and the metallic member.

5. The antenna component according to claim 3,
wherein the metallic member comprises a plate shape extending in the longitudinal direction parallel to an axis of the coil antenna, and
wherein at least one edge of the metallic member extending in a direction of the axis of the coil antenna is bent towards the coil antenna.

5. The antenna component according to claim 3,
wherein the metallic member comprises a rectangular plate shape having a lengthwise direction side extending in a direction orthogonal to the longitudinal direction when viewed from a direction normal to the metallic member in which the metallic member overlaps the porous member, and
wherein at least one side of the metallic member is bent towards the main body.

7. The antenna component according to claim 1, wherein the metallic member comprises copper or aluminum.

8. The antenna component according to claim 1, wherein the metallic member is disposed on only one side of the main body.

9. An antenna component, comprising:
a case;
a core disposed in the case and extending in a longitudinal direction;
a coil antenna wound about the core; and
a metallic member extending in the longitudinal direction with a distance between the case and the coil antenna,
wherein the metallic member comprises a lower resistivity than a resistivity of iron.

10. The antenna component according to claim 9, further comprising a porous member disposed in the case and between the coil antenna and the metallic member to maintain the distance between the coil antenna and the metallic body.

11. The antenna component according to claim 10, wherein the porous member has elasticity and is compressed between the coil antenna and the metallic member.

12. The antenna component according to claim 10,
wherein the metallic member comprises a plate shape extending in the longitudinal direction parallel to an axis of the coil antenna, and
wherein at least one edge of the metallic member extending in a direction of the axis of the coil antenna is bent towards the coil antenna.

13. The antenna component according to claim 10,
wherein the metallic member comprises a rectangular plate shape having a lengthwise direction side extending in a direction orthogonal to the longitudinal direction when viewed from a direction normal to the metallic member in which the metallic member overlaps the porous member, and
wherein at least one side of the metallic member is bent towards the core body.

14. The antenna component according to claim 10, wherein the metallic member includes copper or aluminum.

15. The antenna component according to claim 10, wherein the metallic member is disposed on only one side of the core.

16. An communication system comprising:
a metallic body extending in a longitudinal body; and
an antenna component attached to the metallic body and including:
a main body including a core extending in the longitudinal body when the antenna component is attached to the metallic body and a coil antenna wound about the core, and
a metallic member extending in the longitudinal direction and disposed between the coil antenna and the metallic body with a distance therebetween,
wherein the metallic member has a lower resistivity than the metallic body.

17. The communication system according to claim 16, wherein the antenna component further includes a porous member disposed between the coil antenna and the metallic member to maintain the distance between the coil antenna and the metallic body.

18. The communication system according to claim 17, wherein the porous member has elasticity and is compressed between the coil antenna and the metallic member.

19. The communication system according to claim 16, wherein the metallic member is disposed on only one side of the main body between the coil antenna and the metallic body.

20. The communication system component according to claim 16, wherein the metallic member comprises copper or aluminum.
